(19) United States
(12) Patent Application Publication
(10) Pub. No.: US 2025/0046020 A1
(43) Pub. Date: Feb. 6, 2025

(54) Method and a System for Creating Persistent Augmented Scene Graph Information

(71) Applicant: Cisco Technology, Inc., San Jose, CA (US)

(72) Inventors: Joel Abraham Obstfeld, Bushey (GB); Ronnie I. Dan, Modiin (IL); Louis Gwyn Samuel, Cranham (GB); Guillaume Sauvage de Saint Marc, Sevres (FR)

(21) Appl. No.: 18/363,076

(22) Filed: Aug. 1, 2023

(51) Int. Cl. G06T 19/00; G06V 20/20

(52) U.S. Cl. CPC G06T 19/006; G06V 20/20

(57) ABSTRACT

Embodiments relate to a technique for creating persistent augmented scene graph information by a computing system comprising a scene graph. A plurality of real-world scene graphs of a physical environment are obtained from one or more computing devices. A plurality of objects are detected from the plurality of real-world scene graphs. For each object and between each object, object data including geometrical information, positional information, semantic information, and state information of each object within the real-world scene graphs from different points of view are determined. Composite object data of each object is created based on the object data. The composite object data of each object is mapped to the scene graph, and a scene graph information is created. The scene graph information is updated to each one or more computing devices, and the scene graph information corresponds to a full view of the physical environment.

### TECHNICAL FIELD

The present disclosure relates generally to an augmented reality (AR) field, and more particularly, to a system and a method to create, maintain and distribute persistent localized structural scene graph properties and information.

### BACKGROUND

Augmented reality (AR) is a technology used rapidly in enterprise environments. A typical AR system may be packaged and delivered as a standalone device. The AR system or AR device when present in a physical environment forms its understanding of the physical environment when the system or device is enabled. For example, the AR device, when enabled, performs anchoring and orientation maneuvers to identify its position within the environment and then generates and populates scene graphs of the environment according to its position and orientation. The AR device may rely on multiple sensory inputs obtained from the physical environment. For example, the sensory inputs may include accurate location, orientation, object detection and classification, surface detection and tracking, user intent analysis, etc. Some scenarios enable the AR device to rely on other devices to derive information about the environment. For example, the AR device relies on other sensory devices, such as smart devices, cameras, etc. However, obtaining sensory information from other devices about the environment may cause the AR device to experience latency and functional issues due to network and synchronizing restrictions. A user, when using the AR device, may experience latency, which may be one of the factors for determining whether the user AR experience of the user is effective and functional. For example, if the latency is too high, the user's AR experience is ineffective, and the overall AR experience degrades to the point of becoming inoperable or useless to the user.

The standalone devices may have multiple issues, for example, the devices are bulky, big, and have a short battery life. The standalone devices are expensive and add cost as per added versions. The devices may not determine information about the environment accurately due to data latency and data lag and need to turn off when not in use, which may restrict perceiving the information about the environment. The standalone devices may be embedded with cutting-edge technology, but may have limited capability and fidelity due to power and functional limitations that depend on the versions of the device. Thus, conventional approaches enable the AR device to generate scene graphs and understand the environment in a temporary manner. Specifically, the scene graphs of the environment are generated temporarily by the AR device itself and are populated each time when the AR device may be enabled or restarted. After enabling or restarting the AR device, the user is required to perform the anchoring and orientation maneuvers from scratch for establishing the user's position within the environment and the scene graph, respectively. Also, conventional approaches require the AR device to restart its functions to form the understanding of a new experience. In some situations, the AR device may not be informed or supported by the environment or space around the AR device. In such cases, the AR device, in isolation, must rely purely on its own sensory input in order to derive its perception of the environment.

Presently, AR devices and/or AR systems may be vertically integrated solutions that do not rely on third-party systems or sensory sources. The user may prefer adopting lower-cost consumption devices. However, it is inevitable that lower-cost devices, if fully self-contained, may be less capable and therefore likely to offer lower-quality experiences to the user. The lower-cost devices may have reduced operational lifetime due to power constraints and are likely to have functional limitations when compared to more capable, more expensive devices. The user may incur a high incremental cost for using any additional or upgraded version of the AR device. In such scenarios, the capabilities of the AR device may be restricted according to the version of the AR device, which may be inadequate or unsatisfactory for the user's AR experience. For example, a common version of the AR device worn by the user on the forehead includes challenges like the AR device may not detect an occluded object, the AR device may not determine the geometry of the physical environment, and the AR device may not compute accurate spatial perception, semantic perception, and localization of spatial objects.

Further, conventional methods and systems of AR technology are restricted to generating AR graphics in current video scenes, performing local computation according to characteristics of the device, creating virtual objects with anchoring techniques, augmenting the display of certain virtual objects, and locating items within the field of view (FOV) of the viewing device.

The current AR devices may not support the functionality of sharing AR data and AR state information with other devices since methods that support such sharing according to AR device capabilities, are not available. For example, the current AR devices do not share the AR device's perception of the environment to improve other user's AR experience. The AR data and AR state information may be local to the user or user device only from a single perspective rather than world view (according to all the users and device's view), which is not shared with other devices, and may not be spatially optimized by input from additional devices and users.

### BRIEF DESCRIPTION OF THE DRAWINGS

FIG. 1 illustrates a distributed network environment with a computing system communicating with multiple applications and devices for creating scene graph information, according to an embodiment.

FIG. 2 depicts an example flowchart for generating and augmenting scene graph information of an environment, according to an embodiment.

FIG. 3 illustrates an example of the physical environment with all devices and objects, and the computing system to generate a scene graph information corresponding to the world-view perspective of the environment.

FIG. 4 illustrates a flowchart for creating scene graph information and rendered to the user device, according to an embodiment.

FIG. 5 illustrates an example computer system.

### DETAILED DESCRIPTION

### Overview

Embodiments of the present disclosure relate to a method for creating persistent augmented scene graph information by a computing system. The method includes obtaining a plurality of real-world scene graphs of a physical environment from one or more computing devices. In one embodiment, each real-world scene graph corresponds to a point of view of a computing device. The method includes detecting a plurality of objects from the plurality of real-world scene graphs for the physical environment based on different points of view of the one or more computing devices. After detecting the plurality of objects, object data including geometrical information, positional information, semantic information, and state information of each object within the real-world scene graphs may be determined from different points of view. Based on the object data, composite object data of each object may be created. The composite object data of each object may be mapped to the scene graph. A scene graph information may be created based on mapping of the composite object data. The scene graph information may be updated to each of the one or more computing devices. The scene graph information may correspond to a full-view or worldview of the physical environment.

Embodiments of the present disclosure relate to a system for creating persistent augmented scene graph information. The system includes one or more processors and one or more computer-readable non-transitory storage media in communication with the one or more processors. The one or more computer-readable non-transitory storage media include instructions, that when executed by the one or more processors, are configured to cause the system to perform one or more functions. The system may be configured to obtain a plurality of real-world scene graphs of a physical environment from one or more computing devices. Each real-world scene graph corresponds to a point of view of a computing device. The system may be configured to detect a plurality of objects from the plurality of real-world scene graphs for the physical environment based on different points of view of the one or more computing devices. The system may be configured to determine object data comprising geometrical information, positional information, semantic information, and state information of each object within the real-world scene graphs from different points of view. The system may be configured to create composite object data of each object based on the object data. The composite object data of each object may be mapped to the scene graph. The system may be configured to create a scene graph information based on the mapping of the composite object data. The system may be configured to update the scene graph information to each one or more computing devices. The scene graph information corresponds to a full view of the physical environment.

Embodiments of the present disclosure relate to one or more computer-readable non-transitory storage media including instructions that, when executed by one or more processors of a computer system, are configured to cause the one or more processors to perform one or more functions. The processors may be configured to obtain a plurality of real-world scene graphs of a physical environment from one or more computing devices. Each real-world scene graph corresponds to a point of view of a computing device. The processors may be configured to detect a plurality of objects from the plurality of real-world scene graphs for the physical environment based on different points of view of the one or more computing devices. The processors may be configured to determine object data comprising geometrical information, positional information, semantic information, and state information of each object within the real-world scene graphs from different points of view. The processors may be configured to create composite object data of each object based on the object data. The composite object data of each object may be mapped to the scene graph. The processors may be configured to create a scene graph information based on the mapping of the composite object data. The processors may be configured to update the scene graph information to each one or more computing devices. The scene graph information corresponds to a full view of the physical environment.

The embodiments provide a solution where information and services offered by the host space augment those of the AR system itself. The critical temporal, spatial, and contextual challenges of AR are addressed by edge sensing and computing as integral parts of the host space itself. An AR model as disclosed provides interaction between the AR devices and a host space device. With the host space device being the generator, custodian, and connection point, the scene graphs can be leveraged by the AR devices. Conventionally, AR scene graph generation is temporary by the AR device itself and needs to update through ongoing self-sensing, detection, and orientation. By comparison, a persistent host space scene graph is comprehensive, rich, and constantly up to date. One of the advantages of the embodiments relates to providing a worldview of the environment to the AR devices. For example, the objects that are visually occluded from the view of the one of the users are viewable with the worldview AR scene graph. The present disclosure generates scene graph information including the information of objects that are occluded from the user's view. The disclosure relates to the applicability of communication technologies including Wi-Fi and 5G cellular radio to AR/VR, and communication technologies including Wi-Fi and 5G cellular radio applicability to edge-use scenarios. For example, the applicability of communication technologies including Wi-Fi and 5G cellular radio to AR can address the latency requirements necessary to be utilized for augmenting AR experiences. Conventional approaches define local computation that is related to a 5G-carrier-centric architecture system or a cloud-based architecture system, and in contrast, embodiments of the present disclosure define edge computation where the edge architecture is located within the host space, i.e., sensing and computation may be provided to the host space and the generated AR scene graph may be shared back from the host space to the devices. The solution proposed in this disclosure offers a novel topology that may be able to accommodate flexible consumption and interaction modalities, with a wide array of applications including, but not limited to, indoor navigation, retail, hospitality, health and safety, healthcare, manufacturing, logistics, etc.

Other technical advantages will be readily apparent to one skilled in the art from the following figures, descriptions, and claims. Moreover, while specific advantages have been enumerated above, various embodiments may include all, some, or none of the enumerated advantages.

### EXAMPLE EMBODIMENTS

To solve the existing challenges, there is a need for computer-implemented techniques for reducing latency and exhaustion of device battery life for AR devices in combination with techniques for sharing AR scenes and scene graph information between and among each device. There is also a need for generating and providing access to the most up-to-date scenes and scene graph information to provide a sense of a full view of the entire environment independent of the device version and a particular point of view to which a device may be restricted. Also, there is a need to localize persistent detection of the presence of objects in the entire environment and update the AR scene graph information.

Embodiments of the disclosure provide augmented reality (AR) techniques for augmenting AR systems and AR applications with distributed persistent localized structural scene graph information. The embodiments relate to an AR system that may be incorporated into a host space or a physical environment to generate a scene graph and incorporate scene graph information from multiple scene graphs of multiple devices for augmenting users' AR experiences. The AR system may be configured for receiving multiple real-world scene graphs from multiple user devices, localizing persistent sensing of each object in each scene graph by computing logical and spatial relationships, geometrical, positional, semantic and state information of each object in different real-world scenes, creating the composite object data that may include overlays, overlaps, connection, edge connection of objects in different scenes, mapping the composite object data to the AR scene graph, generating scene graph information for updating to computing devices in the physical environment to experience a full view including an integral part of the physical environment. The embodiments also relate to modifying the real-world scene of a particular user device to include a world view or world perception of the environment (for example, including viewing and information about the occluded objects) rather than restricting the particular user device to view objects and the physical environment components (physical objects) with a restrictive field-of-view (FOV) perspective, for example, occluded objects may not be visible. Additionally, embodiments disclose a novel approach for sharing real-time information pertaining to a scene graph information, for example, information of the objects and environment that may be in view of the user device and objects that may be occluded from the user device view. In an embodiment, the scene graph information may be shared among and between different devices and units that may be associated with the physical environment.

Embodiments disclose a method for creating persistent augmented scene graph information by a computing system. The method may be related to generating scene graph information to provide world perception or a full view of an entire physical environment or host space, which may be a room, zone, region, area, or physical space. The world perception or the full view may be corresponding to including information on each object detected and visible to each device in the physical environment in its respective perspective. In the environment, one or more computing devices or user devices, for example, AR device, AR headset device, smart glasses, etc., may be gazing at the environment in corresponding viewpoints, views, or perspectives. Each device may be configured to generate real-world scene graphs of the environment in the corresponding viewpoint. Each real-world scene graph may be included with one or more objects, entities, or items and the user devices may generate scene graph data from the perspective the user devices may be viewing the physical environment. Exemplary objects may be electronic devices, smart devices, smart objects with smart features, including but not limited to, smart television, smart light bulb, and other particular objects that may be other than devices like chairs, tables, couches, side tables, etc. In an embodiment, the objects may be people in the environment (room). Each of the objects may be viewable by different devices from different viewpoints. The computing system may be configured to obtain multiple real-world scene graphs from multiple devices and locate each object in each real-world scene graph differently depending upon the viewpoint of the corresponding device. Thus, each object may be detected or localized with persistent sensing in each real-world scene graph. For each object, a logical relationship and a spatial relationship may be determined along with geometrical, positional, semantic, and state information of each object that may be computed based on the different viewpoints. In an embodiment, anchor points and orientation points of each object may be determined and computed in each real-world scene graph based on the logical relationship and spatial relationship. The computation of geometrical, positional, semantic, state information, along with logical, spatial, anchor, and orientation points of each object from each real-world scene graph provides a determination of composite object data from overlays, overlaps, connections, and edge computations of the objects. In this way, each object may be located accurately in a world-view perspective, i.e., in a full-view perspective, for example, based on information from different scene graphs of different devices. From the composite object data of the objects, at least one scene graph information may be generated and updated to the user devices to locate and learn scene graph information from a full view perspective (for example, scene graph information of all the devices). The scene graph information may be composite information of scene graph details of all devices that may be shared among each other. In an embodiment, the present disclosure relates to creating, maintaining and distributing information from a scene graph from and to all the devices in the environment to view the environment with full view perspective.

The scene graph information may be used to modify the currently generated real-world scene graph of a particular device to enable viewing the environment with the composite information of scene graph details from all devices and thus enabling a full-view perspective, despite of the viewpoint of the devices. For example, consider two devices where a first device may be viewing the space with a first perspective viewpoint, and a second device may be viewing the same space but with a second perspective viewpoint. The composite scene graph information generated from both devices may be provided to display at the first device with the corresponding first perspective viewpoint and at the second device with the corresponding second perspective viewpoint. Both devices may be enabled to view the full view of the environment. In an embodiment, the composite scene graph information may be provided to display according to type and characteristics of the particular device. The type and characteristics may correspond to the version, configurations, functional capabilities, and operational capabilities of the devices. For example, a low-end device may be enabled to view the composite scene graph information in a particular manner according to low-end device capabilities, and a high-end device may be enabled to view the composite scene graph information according to high-end device capabilities. In this way, the embodiments support any device and may enable coverage of the full view of the environment independent of the configurations or operational restrictions of the devices.

Embodiments relate to data repositories to store multiple real-world scene graphs, scene graph details/information from individual devices, configuration information about each computing device and user device, details of each object and entity, for example, dimension data, kind of object whether the electronic device or non-electronic object, basic entities, etc., room or environment or space data including geometrical data of the environment. The data repositories may also store composite scene graph information and augmented scene graphs information that are being generated at any point in time, for example, generated in the past, recent, and/or in real-time. In an embodiment, the data repositories may be configured to store updated real-world scene graphs, modified scene graphs, updated composite scene graph information, and any updated information about the environment that may affect the generation of a most up-to-date AR scene graph information/details. In this way, the user may be provided with the most up-to-date or real-time generated AR scene graph information since the composite scene graph information may be continuously updated based on updated real-world scene graphs.

In particular embodiments, one or more machine learning models may be utilized for augmenting AR scene graph information. The one or more machine learning models may be utilized to determine composite object data from the overlays of objects in the real-world scene graphs and generate composite scene graph information. A machine learning model may be configured to predict the determination of the kind of AR scene graph information required by the user at a given point in time and provide an augmented AR scene graph information accordingly. The machine learning model may be trained with an updated output of AR scene graph information created in real-time. For example, the machine learning model may be trained and updated in real-time using the real-time updates of composite object data and the scene graph information. In this way, the machine learning models improve efficiency in predicting the kind of AR scene graph information outputs according to real-time scenarios/contexts associated with the user and device, so that the user may be enabled with the best AR experience in real-time. Additionally, the machine learning model may be updated with user input to train the model for predicting accurate AR scene graph information generation with world-view perception, for example, composite scene graph information from all the devices including the scene graph of the computing system. This helps in reducing the potential for latency and performance issues while providing a quick and accurate augmented AR experience to each user.

Embodiments of the disclosure provide visual-based and audio-based outputs corresponding to the augmented AR scene graph information. The visual-based and/or audio-based outputs may depend upon features and configuration supported by the user devices and/or the computing devices. Additionally, the visual-based and/or the audio-based outputs may be generated according to the type of device, characteristics of the device, movement of a wearer or the device, position, and intent of the wearer, time, and location within the physical environment.

Particular embodiments disclose a distributed networking system comprising the computing system associated with the AR system and several Internet of Things (IoT) devices, user AR devices, electronic devices, and any device capable of provisioning AR experience. The computing system communicates with AR devices, IoT devices, and other devices over a network environment enabling to share the scene graph information among one another to view the environment with the full-view or the world-view perspective independent of any field of view or point of view, or region of interest with which the device may be restricted. The computing system can utilize third-party devices, third-party systems, and third-party edge componentry communicatively connected over the network system to generate augmented AR scene graph information and provide features of AR experiences to AR clients or AR users.

The embodiments disclosed herein are only examples, and the scope of this disclosure is not limited to them. Particular embodiments may include all, some, or none of the components, elements, features, functions, operations, or steps of the embodiments disclosed herein. Embodiments according to the present disclosure are in particular disclosed in the attached claims directed to a method, a storage medium, a system, and a computer program product, wherein any feature mentioned in one claim category, e.g. method, can be claimed in another claim category, e.g. system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

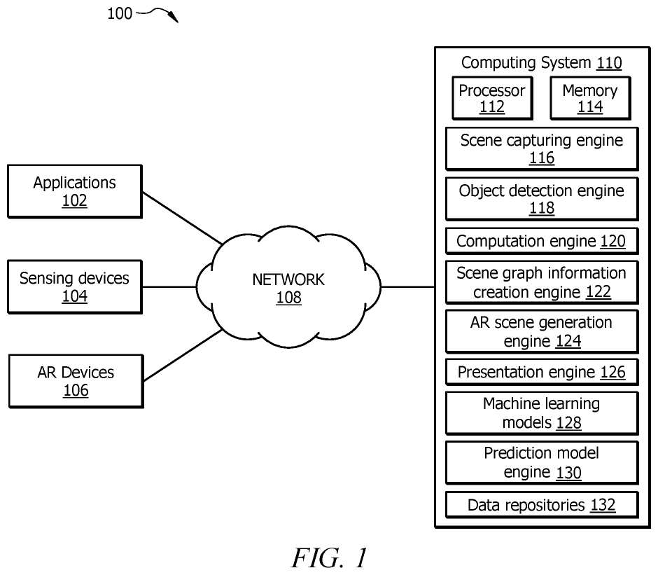

FIG. 1 illustrates a system 100 that includes various interactive devices, sensors, system applications, device applications, and other units that may support and provide AR services and experiences.

In the example of FIG. 1, a system 100 comprises one or more components associated with AR-related applications 102, one or more sensing devices 104, and AR devices 106, each of which is communicatively coupled to a computing system 110 via a data communication network 108. In particular embodiments, the system 100 may be any of electronic systems or electronic devices including hardware, software, or embedded logic components or a combination of two or more such components and capable of carrying out the appropriate functionalities implemented or supported to generate, create, and distribute AR scene graphs and AR scene graph information. In an embodiment, the system 100 may be integrated into the physical environment, for example, room, area, physical space, host space, region, etc. As an example, and not by way of limitation, system 100 may include a computer system such as a desktop computer, notebook or laptop computer, netbook, tablet computer, e-book reader, GPS device, camera, personal digital assistant (PDA), handheld electronic device, cellular telephone, smartphone, augmented/virtual reality device, mixed reality (MR) device, other suitable electronic devices, or any suitable combination thereof. In an embodiment, system 100 may be an AR femtocell that may be a localized system for generating and providing AR services to any kind of device associated with a user. In an AR environment, the AR femtocell supports and augments AR experiences.

In an embodiment, the system 100 may comprise one or more processors programmed to implement computer-executable instructions that are stored in memory or one or more memory units, or data repositories of the system 100. In an embodiment, the one or more processors of the system 100 may be configured to implement the functionality of the one or more components associated with the applications 102, sensing devices 104, AR devices 106, and computing system 110. In particular, the one or more processors of the system 100 may be configured to operate or control any of the one or more components (102, 104, 106) and the computing system 110, including augmented reality device functionalities, virtual reality (VR) device functionalities, and mixed reality (MR) device functionalities that are configured to scan and generate real-world scene graphs in real-time relating to any of the physical environments. In exemplary embodiments, the processors may be configured to generate extended reality (XR) scene graphs including any AR or VR scene graphs, and MR scene graphs. The one or more processors of the system 100 may be configured to obtain real-world scene graphs via application programming interface (API) calls from each application 102, sensing device 104, AR device 106, and the computing system 110. The one or more processors of the system 100 may be configured to perform and implement any of the functions and operations relating to generating and representing the scene graph information of the physical environment. The processors carry out one or more techniques including, but not limited to, device or object tracking operations; device point of view tracking maneuvers, position, and orientation detecting techniques for device and user; logical relationship and spatial relationship detection between each object, people and users (wearing or using application 102, sensing device 104, AR device 106, and computing system 110); anchoring techniques; edge computations of each object, the orientation of each object, and geometric detection techniques; position tracking operations; semantic detection techniques; and state detection of each object. In an embodiment, system 100 may be further configured to determine and detect versions, configurations, functional capabilities, and operational capabilities of the one or more components (102, 104, 106) and computing system 110.

In some embodiments, system 100 may be further configured to detect the intent of the user to interact with any of the one or more components (102, 104, 106) and/or objects in the environment through one or more commands including, but not limited to, any head gesture, hand gesture, voice gesture, finger taps, drag and drop movement, finger pinching, rotating movement, bloom gesture, resizing, selecting, moving, a natural language query or commands, and any other kind of AR-related interaction commands. In an embodiment, system 100 may further include a graphical user interface (GUI) or any display unit to enable users to view the environment from different points of view.

In particular embodiments, the system 100 includes a data communication network 108 for enabling communication and interoperation of each of the one or more components (102, 104, 106) and the computing system 110 with one another enabling the users to access and interact with any of the real-world scene graphs and a plurality of objects in each real-world scene graph corresponding to the physical environment. In an embodiment, each of the one or more components (102, 104, 106) and the computing system 110 may communicate and exchange information via any suitable links. For example, the links may include but are not limited to, one or more wireline (for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, the links may further include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular technology-based network, a satellite communications technology-based network, another link, or a combination of two or more such links. Links need not necessarily be the same throughout the system 100. One or more links may differ in one or more aspects from one or more other links.

In some embodiments, system 100 includes the data communication network 108, which may include any suitable network. As an example and not by way of limitation, one or more portions of network 108 may include an ad hoc network, an intranet, an extranet, a VPN, a LAN, a WLAN, a WAN, a WWAN, a MAN, Internet or a portion of the Internet, a portion of the PSTN, Bluetooth, a cellular telephone network, or a combination of two or more of these. Network 108 may include one or more networks. In an embodiment, the data communication network 108 may be implemented by any medium or mechanism that provides for the exchange of data and information relating to scene graphs to or from each of the one or more components (102, 104, 106) and the computing system 110. In an embodiment, the data and information exchange includes, but is not limited to, live streams, live state, and real-time data including real-time created real-world scene graphs, AR scene graphs, VR scene graphs, MR and/VR scene graphs, three-dimensional (3D) maps, object-centric maps, edge computations, anchoring information, semantic data, context data, device gazing data, vector data associated with a point of view of the device, device and object identification information, and/or multi degrees of freedom (DOF) (for example 6 DOF) of the poses of the user or the AR device, orientation and position data, the one or more instructions of the users, a field of view or point of view of the device and/or user, and the one or more commands with the intent of accessing and interacting by the users. For example, the 6 DOF of poses of the AR device may be associated with movement of the user in a three-dimensional space. The 6 DOF may be detectable based upon identification of all objects that are in line-of-sight of the user. After localizing the user in the physical environment in terms of the different poses of the AR device, one or more objects, such as, television, chairs, tables, couches, side tables, etc., may be detected. In some embodiments, the data and information exchange includes but is not limited to, composite scene graph information, AR scene graph information, and other scene graph information including all XR associated scene graph information from individual applications 102, the sensing devices 104, the AR devices 106, and the computing system 110. The data and information exchange enables the devices, applications, and systems to generate and share real-time information pertaining to the scene graph information that may include persistent localization of objects and items.

In particular embodiments, system 100 enables the users, the one or more components (102, 104 106), and the computing device 110 to communicate and interact with each other to share the real-time information pertaining to the composite scene graph information and AR scene graph information through an application programming interfaces (API) or other communication channels. This enables the components to share, distribute, access and view the scene graph information of all the components.

In some embodiments, the system 100, each of the one or more components (102, 104, 106), and the computing system 110, may include a web browser and may have one or more add-ons, plug-ins, or other extensions. The user may use a computing device to enter a Uniform Resource Locator (URL) or other address directing the web browser to a particular server (such as server, or a server associated with a third-party system). The web browser may generate a Hyper Text Transfer Protocol (HTTP) request and communicate the HTTP request to server or hub. The server may accept the HTTP request and communicate to each of the one or more components (102, 104, 106), computing system 110, and the system 100 one or more Hyper Text Markup Language (HTML) files responsive to the HTTP request. A webpage is rendered based on the HTML files from the server for presentation to the user with the intent of providing access and interaction with composite scene graph information. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts, combinations of markup language and scripts, and the like. Herein, reference to a webpage encompasses one or more corresponding webpage files (which a browser may use to render the webpage) and vice versa, where appropriate.

In some embodiments, the computing devices implementing the applications 102, the sensing devices 104, and the AR devices 106 may be a head-mounted display device (HMD), an electromyographic wearable device (EMG), a head-up display device (HUD), AR glasses (smart glasses), smartphone AR (mobile AR), tethered AR headsets and any other devices with AR features. AR is a form of reality that has been adjusted in some manner before presentation to a user, which may include, e.g., virtual reality (VR), augmented reality, mixed reality (MR), a hybrid reality, or some combination and/or derivatives thereof. AR content may include completely generated AR scene graph content that may be combined with captured content (e.g., real-world photographs or images, live streams, state). The AR content may include video, audio, haptic feedback, or some combination thereof, any of which may be presented in a single channel or in multiple channels (such as stereo video that produces a three-dimensional effect to the user and/or viewer). An AR system that provides the AR content in the form of real-world scene graphs or AR scene graphs may be implemented on various platforms, for example, the head-mounted display (HMD) connected to a host computer system (for example, AR femtocell) or the computing system 110, a standalone HMD, a smart device, a mobile device, or any of the devices or any other hardware platform capable of providing AR scene graph information, having scene graph details collated from all the components (102, 104, 106), corresponding to the environment to one or more users and/or the viewers.

In some embodiments, the computing devices of the applications 102, the sensing devices 104, and the AR devices 106 may comprise one or more processors, a memory for storing computer-readable instructions to be executed by one or more processors, and a display. The memory may also store other types of data to be executed on the one or more processors. Each of the components (102, 104, 106) may be associated with one or more sensors, object tracking units, eye tracking units, red green blue (RGB) units, simultaneous localizing and mapping (SLAMs) units, inertial measurement units (IMUs), infra-red cameras, eye gazing units, anchoring computation techniques, semantic and context analyzer, field of view detecting units, gyroscopes, orientation sensors, position sensors, earphones, Global Positioning System (GPS) receivers, power supply, wired and/or wireless interfaces, I/O components and other units that may be capable of generating the real-world scene graph information and the AR scene graph information. In an embodiment, the one or more sensors may include but are not limited to image sensors, a biometric sensor, a motion and orientation sensor, a location sensor, light detection and ranging (LIDAR) sensors, radio detection and ranging (RADAR) sensors and Wi-Fi sensors. The image sensors, for example cameras, may be head-worn. In a non-limiting embodiment, the image sensors comprising the cameras may include digital still cameras, digital moving images, or video cameras. The image sensors are configured to capture images or live streams of the physical environment where the user is located. In an embodiment, the image sensors capture the images and/or live streams of the physical environment in real-time and provide the user with viewing a 3D object-centric map representation of all objects as real-world scene graph information or AR scene graph information on the display. In particular embodiments, the image sensors may include physical space or room-based sensors. For example, the AR device 106 not only draws from users' individual head-mounted displays but also may use a room-based sensor to collect information about rooms, zones, regions, areas, and physical spaces of the physical environment. The space or room-based sensor detects and/or collects information from the physical environment, for example, a space, such as an office, living room, media room, kitchen, or other physical space. In an embodiment, the image sensors detect users wearing or using the one or more components (102, 104, 106, 110) and the people present in the environment. The space or room-based sensor may also include one or more audio sensors or transducers, for example, omnidirectional or directional microphones. The audio sensors or transducers may detect sound from animate objects, for example, one or more users or other people in the ambient physical environment. The audio sensors or transducers may detect sound from inanimate objects, for example, televisions, stereo systems, radios, or other appliances. The motion and orientation sensor may include an acceleration sensor, for example, an accelerometer, a gravity sensor, a rotation sensor like a gyroscope, and/or the like. The location sensor may include an orientation sensor component (e.g., a Global Positioning System (GPS) receiver), an altitude sensor (e.g., an altimeter or barometer that detects air pressure from which altitude may be derived), an orientation sensor component (e.g., a magnetometer), geolocation sensor to identify the location of the user in a particular zone or region or space of the physical environment and so forth. The one or more sensors may also include, for example, a lighting sensor, such as a photometer, a temperature sensor, such as one or more thermometers that detect ambient temperature, a humidity sensor, a pressure sensor such as a barometer, acoustic sensor components, one or more microphones that detect background noise, proximity sensor components, infrared sensors that detect nearby objects, gas sensors, such as gas detection sensors to detect concentrations of hazardous gases to ensure safety or to measure pollutants in the atmosphere, or other sensors that may provide an indication, measurement, or signal corresponding to the surrounding physical environment. It should be appreciated that only some of the sensors are illustrated, and some embodiments may comprise fewer or greater sensors and/or sub-sensor units, and the illustration should not be seen as limiting.

In some embodiments, the computing system 110 comprise any kind of electronic device, for example, and not by way of limitation, a desktop computer, laptop computer, tablet computer, mobile phone, notebook netbook, workstation, e-book reader, GPS device, camera, personal digital assistant (PDA), handheld electronic device, cellular telephone, smartphone, augmented/virtual reality device, personal computers (PCs), entertainment devices, set-top boxes, Televisions (TVs), mobile gaming machines, smart watches, digital wristbands, gaming consoles, portable computers such as ultrabooks, all-in-one machines, light detection and ranging (LIDAR) devices, TVs, internet TVs, display devices, home appliances, thermostat, refrigerator, washing machine, dishwasher, air conditioners, docking stations, game machines, digital cameras, watches, interactive surfaces, 3D displays, entertainment devices, speakers, smart homes, IoT devices, IoT modules, smart windows, smart glasses, smart bulbs, kitchen appliances, media players or media systems, orientation-based devices; and mobile gaming machines, pico or embedded projectors, medical devices, medical display devices, vehicles, in-vehicle/air infotainment systems, unmanned aerial vehicles, unmanned vehicles, automated guided vehicles, flying vehicles, navigation systems, wearable devices, augmented reality enabled devices, wearable goggles, virtual reality devices, orientation-based devices, robots (robots), social robots, (humanoid) robots (android), interactive digital signage, digital kiosks, vending machines, other suitable electronic device, and combination thereof.

In some embodiments, the computing system 110 may be a standalone host computer system or an on-board computer system integrated with the applications 102, sensing devices 104, and AR devices 106 to create and update scene graphs and composite scene graph information corresponding to the different perspectives of the components (102, 104 106) to update world view perspective of the environment in real-time and dynamically. In an embodiment, the computing system 110 may be integrated into the physical environment, for example, room, area, physical space, host space, region, etc. The computing system 110 may be associated with server computing technology, such as a server farm, a cloud computing platform, a parallel computer, one or more virtual compute instances and/or virtual storage instances, and/or instances of a server-based application. In particular embodiments, computing system 110 may be associated with one or more servers. Each server may be a unitary server or a distributed server spanning multiple computers or multiple data centers. Servers may be of various types, such as, for example, and without limitation, web servers, news servers, mail servers, message servers, advertising servers, file servers, application servers, exchange servers, database servers, proxy servers, and other servers suitable for performing functions or processes described herein, or any combination thereof. In particular embodiments, each server may include hardware, software, or embedded logic components or a combination of two or more such components for carrying out the appropriate functionalities implemented or supported by the server. For example, each server may be configured to generate and store real-world scene graphs, scene graph information, for example, composite scene graph information, and share them with all the devices in the physical environment, so that the devices and the users may view the environment with a full view having the composited scene graph information of all the devices. In this way, each device may be enabled to share its perspective view of the environment locating all the objects with information persistently with all other devices in the environment.

In some embodiments, the computing system 110 comprises a processor 112 and a memory 114. The processor 112 is programmed to implement computer-executable instructions that are stored in memory 114. The computing system 110 may also comprise one or more data repositories 132 and/or data stores, for example, to store multiple real-world scene graph information, details about each computing device and user device, details of each object and entity, for example, dimension data; object type, whether the electronic device or non-electronic object; basic entities; room or environment or space data, including geometrical data of the environment. The data repositories 132 may also store composite scene graph information and augmented scene graph details that are being generated at any point in time, for example, generated in the past, recent, and/or in real-time. In an embodiment, the data repositories 132 may be configured to store updated real-world scene graphs, updated scene graph information, modified scene graph information, and any updated information about the objects in the environment that may affect the generation of a most up-to-date persistent localized AR structural scene graph information. In this way, the user may be provided with the most up-to-date or real-time generated AR scene graph because the composite scene graph information may be continuously updated based on updated real-world scene graphs. In particular embodiments, the information stored in data stores may be organized according to specific data structures. In particular embodiments, each repository and data store may be a relational, columnar, correlation, or other suitable database. Although this disclosure describes or illustrates particular types of databases, this disclosure contemplates any suitable types of databases.

In an embodiment, the computing system 110 may be communicatively connected to any number of applications 102, sensing devices, and AR devices via network 108. For clarity, FIG. 1 shows applications 102, sensing devices 104, and AR devices, but in practical embodiments, the physical environment may include any number of components, and each may be communicatively coupled to the computing system 110. In some embodiments, the computing system 110 may utilize third-party edge components to deliver key data and properties of AR experience to AR clients, and thus enable affordable consumption components (102,104, 106). In order to deliver superior, spatially, and logically optimized AR experiences, the computing system 110 (for example, an AR system) may utilize external third-party systems and devices, locally proximate hardware and software components provided by the environment or a host space within which the AR experience may be physically taking place. For example, a meeting room or a retail store.

In particular embodiments, the computing system 110 comprises stored program instructions organized as the scene capturing engine 116, object detection engine 118, computation engine 120, scene graph creation engine 122, AR scene generation engine 124, presentation engine 126, one or more machine learning models 128, and prediction model engine 130, which in turn may comprise computer-executable instructions.

The scene capturing engine 116 is programmed or configured to obtain and/or access live streams, images, videos, footage, pictures, 3D map representations, virtual map representations, and real-world scene graphs, i.e., AR scene graphs of the environment. In an embodiment, live streams, images, videos, footage, pictures, and real-world scene graphs (AR scene graphs of the environment) may be obtained from the one or more components (102, 104, 106), including any device or component that may be capable of generating real-world scene graphs. In an embodiment, the AR scene graphs of the environment may include scene graph details localizing objects, events, items in the environment. In an embodiment, the real-world scene graphs may have been created or generated by a corresponding component (102, 104, 108) or component from a particular perspective view, field of view and/or point of view, and/or region of interest. In an embodiment, obtaining the real-world scene graphs from different points of view and generating the scene graph information compositing all the scene graph details enable the user to have world view (full view) of the environment allowing one to view occluded objects as well in the environment. In an embodiment, the real-world scene graphs, scene graph details, including 3D maps, virtual maps, virtual scene graphs, images, live streams, etc., may be stored in the memory 114, and/or the data repositories 132, memory units of system 100, or through cloud storage. In an embodiment, obtaining the real-world scene graphs from the one or more components (102, 104, 106) by the locally proximal computing system 110 reduces latency and generates a high-quality, immersive and enjoyable scene graph information with enhanced AR experience for AR users/clients.

The object detection engine 118 may be programmed or configured to detect one or more objects, entities/items present in and around the physical environment. In an embodiment, the one or more objects may be detected based on different points of view to localize persistent sensing of each object from the real-world scene graphs. Exemplary objects may be electronic devices, smart devices, smart objects with smart features, including but not limited to, smart television, smart light bulb, and other particular objects that do not include other inanimate objects like chairs, tables, couches, side tables, etc. In an embodiment, the objects may be people or users (wearing or using the components 102, 104, 106, 110 or associated with system 100) in the environment (room). In an embodiment, object detection engine 118 may utilize machine learning techniques, computer vision technology, augmented reality applications, virtual reality and mixed reality-related techniques, and technologies used for object detection. In an embodiment, 3D map representation may be generated for AR environments. The object detection engine 118 further utilizes simultaneous localizing and mapping (SLAM) techniques, edge computations for object tracking. RGB, real-time inertial measurement units (IMUs), and other related 3D object detection pipelines to scan the entire zone or region or area, or space of the physical environment and then represent each object from the physical environment into real-world scene graphs. For example, the objects may include any furniture like a sofa, table, chairs, appliances such as a washer, refrigerator, TV, smart plugs, smart devices, smart lamps, and other room-defining objects like a kitchen sink, bathtub, doors, windows, flowerpots, pens, books, bottles, etc. In an embodiment, the object detection engine 118 may comprise a local detector, a global detector, and a fusion algorithm for object detection and representation in the form of real-world scene graphs. Each object in the physical environment may be associated with some features, and in particular embodiments, the object detection engine 118 may evaluate those features, including but not limited to physical, context, and semantic features, surface attributes, and data points associated with each physical object and other related features of the objects present or exist in the environment. For example, during object detection, the object detection engine 118 may perform various estimations, such as depth estimation, size estimation, dimension segmentation, instance segmentation, three scale-regression offsets for height, width, and length along with thickness estimation, and other related estimations, to evaluate the features associated with each physical object. In particular embodiments, based on the feature evaluation, the object detection engine 118 may detect one or more data. For example, object detection data, position data, orientation data, logical relationship data, spatial relationship data, anchoring data, edge computation data, data related to a number of people/users, people/user-specific data (position, line of sight, activity, identification), object position and orientation data, object dimension data, geometric data associated with the environment/object, vector data of the objects, semantic data, state data of each object in the environment against which the real-world scene graphs may be generated by the one or more components (102, 104, 106, 100). In an embodiment, object detection engine 118 may also detect the one or more data of each object based on 6DOF. In one embodiment, all the objects may be associated with one or more tags, info-label data, object types, classifiers, and identifications. In some embodiments, the one or more objects may be categorized into one or more categories and stored in the memory 114 and/or the data repositories 132 of the computing system 110. In an embodiment, the one or more objects may be stored in the form of any mapping table, map entries, a list format, a tagged format, lookup table, data structures, relational database, object database, flat file system, SQL database, or no-SQL database, an object store, a graph database, or other data storage. In an embodiment, the object detection engine 118 may construct object details for each object and thereby construct scene graph details based on object detection. The scene graph details may be leveraged by the computing system 110 to composite the details with other scene graph details and create scene graph information for a full view of the environment.

The computation engine 120 may be programmed or configured to determine object data including, but not limited to, geometrical information, positional information, semantic information and state information of each object within the real-world scene graphs and scene graph details according to different points of view. For example, the computation engine 120 may compute overlays, overlaps, and edge computations of each object from different real-world scene graphs, scene graph details. In an embodiment, the computation engine 120 computes the overlays of the objects based on points, lines, edges, corners, cues, and the like. In an embodiment, the overlays of objects may be determined based on various rules, for example, geometric rules, texture rules, animation rules, and so on. In an embodiment, the computation engine 120 may be configured to create composite object data of each object based on the compositing of the object data. The composite object data of each object is mapped to the scene graph of the computing system 110.

The scene graph information creation engine 122 may be programmed or configured to create scene graph information based on the mapping of the composite object data. In an embodiment, the scene graph information creation engine 122 generates the composite scene graph information according to the localization of objects from corresponding points of view of the one or more components (102, 104, 106) including the point of view of the computing system 110. In some embodiments, the scene graph information creation engine 122 creates the composite scene graph information according to a correlation of geometrical data, positional data, semantic data, and state information of each object within the real-world scene graphs. In an embodiment, the composite scene graph information depicts the information and localization of each object in the environment, for example, the world view of the environment to locate, view and update information about each object present anywhere in the environment. In some embodiments, the composite scene graph information may be categorized into one or more categories and stored in the memory 114 and/or the data repositories 132 of the computing system 110. In an embodiment, scene graph information creation engine 122 may be programmed to update the scene graph information to each one or more computing devices where the scene graph information corresponds to a full view of the physical environment.

The AR scene generation engine 124 may be programmed or configured to generate AR scene graphs with the scene graph information, for example, composite scene graph information. In an embodiment, the AR scene generation engine 124 generates the AR scene graphs of the environment to represent the scene graph information of the entire environment with world view or the full view. The generated AR scene graphs may be provided back to each of the one or more components (102, 104, 106) to have the full view of the environment via accessing the scene graph information. For example, each of the one or more components (102, 104, 106) may view the occluded objects that are not visible in the standard field of view or point of view. In some embodiments, the AR scene generation engine 124 may be configured to generate different AR scene graphs and update the scene graph information according to the features, configurations, and points of view of a particular component (102 or 104 or 106). For example, a device 1 viewing the AR scene graph in an ‘X’ point of view may be enabled to represent the scene graph information of the environment in the ‘X’ point of view, and a device 2 viewing the AR scene graph in a ‘Y’ point of view may be enabled to represent the scene graph information of the environment in the ‘Y’ point of view. In this way, the embodiments support any device (low-end or high-end) and may enable coverage of the full view of the environment independent of the point of view or configurations or operational restrictions of the devices. In some embodiments, different scene graph information may be categorized into one or more categories according to the features, configurations, and points of view of the components (102, 104, 106), including computing system 110 and system 100 and stored in the memory 114 and/or the data repositories 132 of the computing system 110.

The presentation engine 126 may be programmed or configured to display the composite scene graph information and the AR scene graph on a display unit associated with the one or more components (102, 104, 106), including display units corresponding to the computing system 110 and the system 100. In an embodiment, the presentation engine 126 may present an AR scene graph with the scene graph information of the environment according to the features, configurations, and points of view of a particular component (102 or 104, or 106). In an embodiment, the presentation engine 126 may select a particular AR scene graph according to the particular device's point of view, configuration, and features, and then display the AR scene graph with the scene graph information on the particular device in the same point of view that the device may be viewing. In some embodiments, the presentation engine 126 may modify a particular real-world scene graph according to the component's (102, 104, 106) point of view, configuration, and features and then create the particular AR scene graph with scene graph information for display at the particular device. In some embodiments, the presentation engine 126 may generate audio-based output associated with the scene graph information based on the component's (102, 104, 106) point of view, configuration, and features. In an embodiment, the audio-based output may be generated independent or in combination with display-based output according to the component's (102, 104, 106) point of view, configuration, and features.

In some embodiments, the computing system 110 includes one or more machine learning models 128 that may be pre-trained and trained over time regularly based on the display-based output and/or audio-based output of the AR scene graphs. The one or more machine learning models 128 may be utilized for augmenting AR scene graphs. The one or more machine learning models 128 may be utilized to determine object data and composite object data based on overlays of objects in the real-world scene graphs and generate composite scene graph information. A machine learning model 128 may utilize prediction model engine 130 to predict the kind of AR scene graph information required by the user at a given point in time and provide an augmented AR scene graph with the scene graph information accordingly. The machine learning model 128 in conjunction with prediction model engine 130 may predict and learn the features, configuration, points of view of the components (102, 104, 106) including the computing system 110 and the system 100 to determine the points of view, features, configuration of the devices, etc. The machine learning model 128 and the prediction model engine 130 may also predict the object tracking and object identification data including position, orientation and other data that may be needed to generate the composite object data. The machine learning model 128 may be trained with an updated output of AR scene graphs with updated scene graph information created in real-time. For example, the machine learning model 128 may be trained and updated in real-time using the real-time updates, for example, display-based output and audio-based output of the scene graph information and the AR scene graphs. In an embodiment, the machine learning model 128 and prediction model engine 130 improve efficiency in predicting the kind of scene graph information outputs according to real-time scenarios the user and device may be associated with, and the user is provided with the best AR experience in real-time with reduced latency and lags. Additionally, the machine learning model 128 may be updated with user input to train the model for predicting accurate AR scene graph generation with a world-view display of the scene graph information of the environment. This helps in providing a quick and accurate augmented AR experience to each user.

In an embodiment, system 100 comprises components that are implemented at least partially by hardware at one or more computing devices or systems, such as one or more hardware processors executing stored program instructions stored in memory for performing the functions that are described herein. In other words, all functions described herein are intended to indicate operations that are performed using programming in a special-purpose computer or general-purpose computer, in various embodiments. FIG. 1 illustrates only one of many possible arrangements of components configured to execute the programming described herein. Other arrangements may include fewer or different components, and the division of work between the components may vary depending on the arrangement.

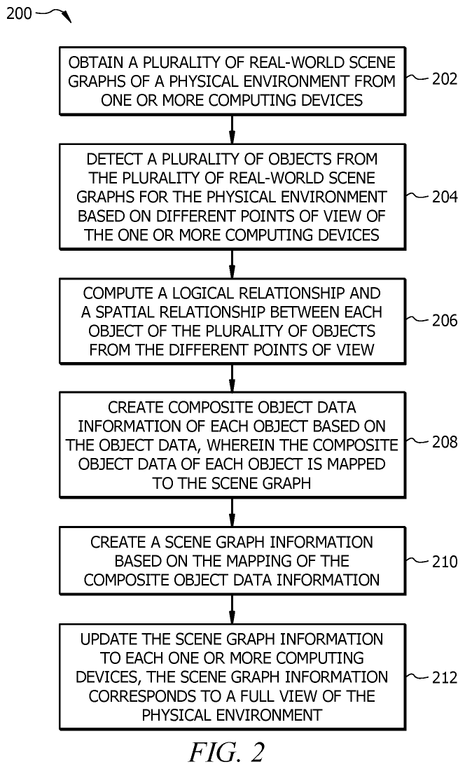

FIG. 2 depicts an example flowchart for generating and augmenting scene graph information of an environment, according to an embodiment. FIG. 2 depicts an example flowchart for a process that may be implemented for one embodiment.

Process 200 uses the computing system 110, which may be the standalone host computer system, an on-board computer system integrated with the one or more devices associated with the applications 102, the sensing devices 104, and the AR devices 106, to create persistent localized structure scene graph information in the AR scene graph (of the computing system 110) corresponding to the world-view perspective of the environment in real-time and dynamically. The method may be related to generating world perception or a full view of an entire physical environment or host space, which may be a room, zone, region, area, or physical space. The world perception or the full view may be associated with representing scene graph information collated and composited from perspectives of all devices, that may be present in proximity or around or in the physical environment itself.

Process 200 begins at step 202 and system 100 obtains a plurality of real-world scene graphs of the physical environment from the one or more devices, for example, devices associated with AR applications 102, the sensing devices 104, and the AR devices 106. In an embodiment, the computing system 110 may capture one or more pictures or videos or live streams of the environment and generates its own real-world scene graphs along with scene graph details. In an embodiment, each real-world scene graph and scene graph details may be generated from a particular point of view of the corresponding component (102/104/106/110) from which the device may be viewing the environment. The processor 112 of the computing system 110 may be programmed to obtain and analyze each real-world scene graph based on the corresponding points of view of the one or more components (102, 104, 106, 110). In an embodiment, the processor 112 of the computing system 110 determines the point of view of the one or more components (102, 104, 106, and 110) that may be viewing the environment and that have generated the corresponding real-world scene graphs with scene graph details.

At step 204, the computing system 110 detects and locates the plurality of objects from the multiple real-world scene graphs and the scene graph details. In an embodiment, the computing system 110 may be configured to locate each object in each real-world scene graph differently depending upon the point of view according to which the real-world scene graph is being generated by the corresponding component (102, 104, 106, 110). Each object may be detected or localized with persistent sensing according to its existence in each real-world scene graph. For example, the computing system 110 may detect each object in each real-world scene graph based on different points of view of the one or more components (102, 104, 106, 110) to localize persistent sensing of each object in the real-world scene graph.

At step 206, the computing system 110 computes or determines object data including, but are not limited to, geometrical information, positional information, semantic information, and state information of each object within the real-world scene graphs and scene graph details from different points of view. In an embodiment, computing system 110 may compute the logical relationship and the spatial relationship of each object from different and multiple points of view. In an embodiment, for each object, anchor point, and orientation point in different and multiple real-world scene graphs may be computed. The anchor point and orientation point for each object may be computed based on the logical relationship and the spatial relationship. Based on the computation, the computing system 110 may create scene data products related to the correlation of the geometrical, positional, semantic, and state information of each object.

At step 208, the computing system 110 may create composite object data of each object based on the object data. In an embodiment, the computation of geometrical information, positional information, semantic information, and state information, logical, spatial, anchor, and orientation points of each object from each real-world scene graph provides a determination of overlays, overlaps, connections, and edge computations of the objects. In this way, each object may be located accurately in environment. In an embodiment, the composite object data of each object is mapped to the scene graph.

At step 210, the computing system 110 may create a scene graph information based on the mapping of the composite object data. In an embodiment, the scene graphs includes the scene graph details that may be composited according to all the perspectives of the components (102, 104, 106) including computing system 110. This aspect eliminates the view of the environment from a restrictive perspective view. In an embodiment, the correlation of geometric, positional, semantic, and state information may be used to create scene graph information.

At block 212, computing system 110 may update the scene graph information to each one or more computing components (102, 104, 106). In an embodiment, the scene graph information corresponds to a full view of the physical environment by locating details, information about objects present anywhere in the environment. The scene graph information may be used and updated into each AR scene graph corresponding to each component (102, 104, 106, 110). In an embodiment, the AR scene graph included with scene graph information may be displayed at the one or more components (102, 104, 106) including a display of the computing system 110. The created scene graph information may be used to modify the currently generated real-world scene graphs and scene graph details of a particular device according to point of view of the particular component (102, 104, 106, 110). The scene graph information enables the devices to view the environment with the full-view perspective in the particular points of view that may correspond to the particular device. Also, the method enables the devices and units in the environment to share real-world scene graph information of one another with augmented AR scene graphs. In an embodiment, the computing system 110 displays the AR scene graphs with the scene graph information at the one or more components (102, 104, 106) including system 110 according to respective point of view of each component (102, 104, 106, 110). In an embodiment, the scene graph information may be provided to display according to the type and characteristics of the particular component (102, 104, 106, 110). The type and characteristics may correspond to the version, configurations, functional capabilities, and operational capabilities of the devices. For example, a low-end device (e.g., computing device 102 implementing an AR application) may be enabled to view the composite scene graph information and the AR scene graph in a particular manner according to low-end device capabilities, and a high-end device (e.g., AR device 106) may be enabled to view the composite scene graph information according to high-end device capabilities. In this way, the embodiments support any device and may enable coverage of the full view of the environment independent of the configurations or operational restrictions of the devices.

The process continuously generates updated AR scene graph information with localized persistence of objects in the multiple real-world scene graphs. For example, the computing system 110 receives updated real-world scene graphs and updated scene graph details from the one or more components (102, 104, 106). In an embodiment, the computing system 110 may scan the environment itself and generate its own real-world scene graph and scene graph data (similar to device constructing scene graph details on its own). Compositing all the updated real-world scene graph information, the AR scene graphs may be updated. The current AR scene graphs at the display may be updated with modified and updated scene graph information. In some embodiments, the scene data products related to the correlation of geometrical, positional, semantic, and state information of each object may be the criteria for updating the scene graph information and AR scene graphs.

In some embodiments, the process also includes pretraining and training the one or more machine models 128 over time based on the updated AR scene graph information being displayed/represented. In an embodiment, the semantics, the contexts, the intent of the user, the time of view, etc., may be one or more factors for pretraining and training the machine learning models 128. The process learns from recently created scene graph information and predicts composite object data of objects for compositing scene graph details of each device. In an embodiment, the process uses prediction models to predict and learn the features, configuration, and points of view of the components (102, 104, 106) including the computing system 110 and the system 100 to determine the points of view, features, configuration of the devices, etc. The process includes training the one or more machine models 128 with the updated AR scene graph information in real-time dynamically. In an embodiment, the training and prediction improve efficiency by providing the optimized AR experience in real-time with reduced latency and lags.

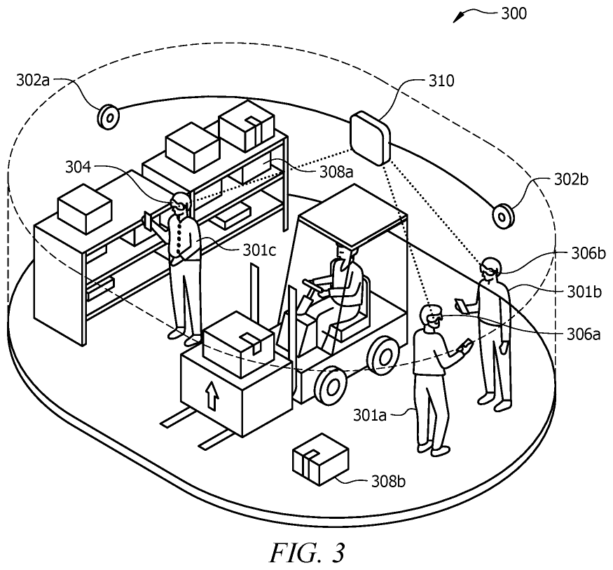

FIG. 3 illustrates an example of the physical environment 300 with devices (302a and 302b), (304) and objects (308a, . . . 308c), and the computing system 310 (110 from FIG. 1) to create a world-view perspective of the environment 300 by distributing scene graph information. FIG. 3 shows an environment 300 integrated with one or more camera or sensing devices, for example, 302a and 302b. The environment 300 shows one or more users 301a-301n wearing devices with AR applications 304 and AR devices (306a, and 306b). Each of the users 301a-301n may be viewing environment 300 from different points of view. For example, the user 301a associated with AR device 306a may be looking in the X direction, and the user 301c associated with device 304 may view in the Y direction. Each device 306a and 304 creates a real-world scene graph and scene graph details according to its point of view. The users 301a and 301c can view the objects that fall in their respective points of view. For example, the user 301a cannot see the occluded object 308a and the user 301c cannot see the occluded object 308b. Environment 300 may be integrated with the computing system 310, which may comprise the role of an AR femtocell. The computing system 310 being the AR femtocell may communicate with AR devices, as well as compute and store information. In an embodiment, the AR femtocell may be able to consume data, for example, scene graphs and scene graph details, from external sensing devices and systems such as video cameras, LIDAR sensors, Wi-Fi sensors, etc. In an embodiment, the AR femtocell may be located in close proximity to a) the input sensing systems and b) the AR devices present within the host space or the environment 300. By locating the computing system 310 or the AR femtocell in close proximity, the latency introduced by physical distance may be minimized. The locality also affords persistent presence, sensing, procession, and maintenance of the most accurate, up-to-date scene graph, scene graph information and world view of the host space or the environment 300, independent of any AR client devices. For example, with worldview of the environment 300, each of the devices 306a and 304 may view the occluded objects 308a and 308b. Each device 306a and 304 may view the worldview of the environment 300 in its own point of view. Furthermore, the scene graph persists and may be maintained by the computing system 310 in the environment 300 when there are no AR client devices present within the locality.

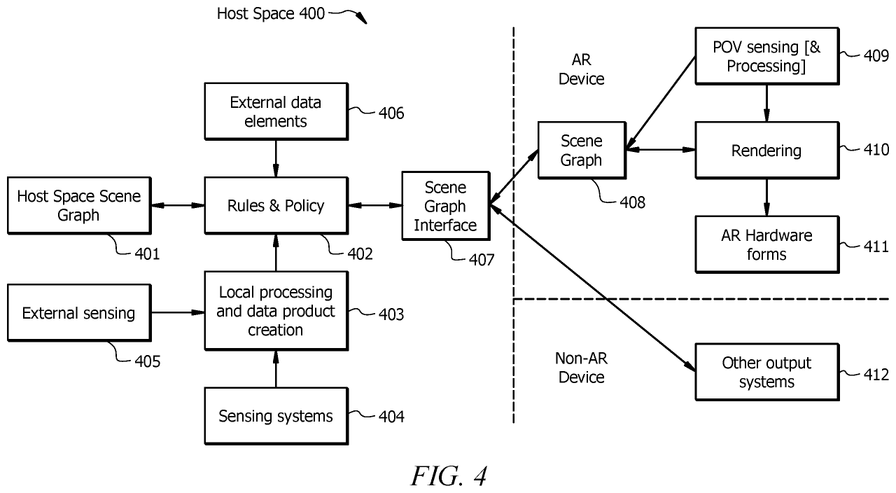

FIG. 4 illustrates a flowchart for creating persistent augmented AR scene graph with persistent localization of scene graph information of a host space 400 and rendered to the user device, according to an embodiment. The host space scene graph 401 may be the persistent AR scene graph with the composited scene graph information providing the worldview perspective of the environment. The host space scene graph 401 may be a software data structure containing composite scene graph information of the real-world scene graphs from multiple devices. The data structure may be persistent and may be available while the computing systems serving the host space 400 are available to provide updated real-world scene graphs continuously in real-time and dynamically. Conventional AR systems do not offer a persistent, continuously updated scene graph and thus the embodiments reduces latency in augmenting the AR scene graphs.

In an embodiment, the host space scene graph 401 interacts with a rules and policy system 402, which acts as a mediating layer that may be written to and read from the scene graph 401. The rules and policy system 402 acts as a mediating layer for sharing AR scene graphs along with scene graph information between the computing system of the host space and each of the client devices (411, 412). In an embodiment, the rules and policy system 402 defines different manufacturing and configuration information associated with each of the client devices (411, 412 including external sensing systems 405) in the host space 400. In an embodiment, the client devices, for example, sensing devices, including video, LIDAR, etc., may be present within the host space and observe, locate, and view objects and events within the environment/host space 400.

In an embodiment, the raw sensor data from each client device (411, 412) may be processed by a discrete software subsystem 403 that creates data products that may include geometry and positional information, as well as semantic and state information about objects within the host space 400. The data product created by software subsystem 403 may be written to the scene graph 401, subjected to the rules and policy system 402. Additional information may be provided from external sensing systems 405 outside of the host space 400. In an embodiment, the external sensing system 405 may be associated with people counting, detecting the presence of individuals within the host space 400 and incorporated into the software subsystem 403. The software subsystem 403 may be associated with local processing and data product creation that can accumulate information from client devices (411, 412) and external sensing system 405 to create scene graph information 401. In an embodiment, the data products may be obtained from external sources 406, which may include external data elements, such as building schematic information, medical information, x-ray information from security scanning systems, or the like. The information from the external sources 406 may be collated and added to scene graph information 401, subject to rules and policy system 402.

In an embodiment, the scene graph interface 407 may be associated with creating AR scene graph information 401, which may be accessed according to rules and policy system 402. Each of the client devices (411, 412) may be associated with its own scene graph details 408 and point of view sensing processing 409, and software 410. The computing system associated with scene graph information 401 enables the devices (411, 412) in the host space to be augmented by the information held in the host space scene graph information 401, which may be accessed by the scene graph interface 407 subject to rules and policy system 402. The resulting scene may be rendered by rendering software 410 and displayed in an appropriate manner for input/output AR device hardware and software 411. In an embodiment, the client device may be input/output AR device hardware and software 411 acts as contributors to the host space scene graph information 401, and informing the scene graph information and thus introducing the capability of sharing scene graph information with other AR devices and users via the shared scene graph. In this way, the approach creates a network effect, improving the overall experience for all participating devices and users.

The host space scene graph information 401 may include the composite scene graph information corresponding to the scene graph details of the devices (411, 412), which may benefit all devices that can leverage the scene graph information and thus view the environment with world view or full view perspective. Because current vertically integrated solutions do not share scene graph information with other AR devices, each device would need to create and maintain its own scene graph details.

In an embodiment, the created AR scene graph information 401 may be provided as audio based sensory output as a form of AR. Instead of using a visual method alone, audio prompts triggered by actions, movement, position, intent, time-spent, location, etc., within and by the host space 400 may be delivered to the wearer of a headset or earpiece. The data contained within the host space scene graph information 401 may also be leveraged as a source for output by non-AR devices 412, such as projection systems, display screens, etc. The non-AR devices 412 may also act as an input source to the host space scene graph 401. In an embodiment, the scene graph 401 within the host space 400 persists when the AR devices enter a space, or enables a new experience (AR application), and the scene graph information 401 may have been already fully constructed and informed by the sensors within the space 404. When enabling the device, the device need not anchor and establish its initial baseline, other than its primary orientation within the host space 400. The rules and policy system 402 may also be applied to create outcomes, which may be driven by the policy. For example, a policy may determine that AR devices of a certain type or of certain characteristics do or do not receive certain parts of the scene graph information 401. For example, low-capability devices may only be exposed to a certain portion of the scene graph information 401. Thus, the embodiments provide a topology that may be able to accommodate flexible consumption and interaction modalities with a wide array of applications, including indoor navigation, retail, hospitality, health and safety, healthcare, manufacturing, logistics, etc.

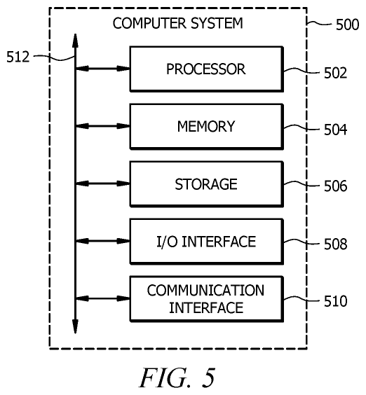

FIG. 5 illustrates an example computer system 500. In particular embodiments, one or more computer systems 500 perform one or more steps of one or more methods described or illustrated herein. In particular embodiments, one or more computer systems 500 provide functionality described or illustrated herein. In particular embodiments, software running on one or more computer systems 500 performs one or more steps of one or more methods described or illustrated herein or provides functionality described or illustrated herein. Particular embodiments include one or more portions of one or more computer systems 500. Herein, reference to a computer system may encompass a computing device, and vice versa, where appropriate. Moreover, reference to a computer system may encompass one or more computer systems, where appropriate.

This disclosure contemplates any suitable number of computer systems 500. This disclosure contemplates computer system 500 taking any suitable physical form. As example and not by way of limitation, computer system 500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 500 may include one or more computer systems 500; be unitary or distributed; span multiple locations; span multiple machines; span multiple data centers; or reside in a cloud, which may include one or more cloud components in one or more networks. Where appropriate, one or more computer systems 500 may perform without substantial spatial or temporal limitation one or more steps of one or more methods described or illustrated herein. As an example and not by way of limitation, one or more computer systems 500 may perform in real time or in batch mode one or more steps of one or more methods described or illustrated herein. One or more computer systems 500 may perform at different times or at different locations one or more steps of one or more methods described or illustrated herein, where appropriate.

In particular embodiments, computer system 500 includes a processor 502, memory 504, storage 506, an input/output (I/O) interface 508, a communication interface 510, and a bus 512. Although this disclosure describes and illustrates a particular computer system having a particular number of particular components in a particular arrangement, this disclosure contemplates any suitable computer system having any suitable number of any suitable components in any suitable arrangement.

In particular embodiments, processor 502 includes hardware for executing instructions, such as those making up a computer program. As an example and not by way of limitation, to execute instructions, processor 502 may retrieve (or fetch) the instructions from an internal register, an internal cache, memory 504, or storage 506; decode and execute them; and then write one or more results to an internal register, an internal cache, memory 504, or storage 506. In particular embodiments, processor 502 may include one or more internal caches for data, instructions, or addresses. This disclosure contemplates processor 502 including any suitable number of any suitable internal caches, where appropriate. As an example and not by way of limitation, processor 502 may include one or more instruction caches, one or more data caches, and one or more translation lookaside buffers (TLBs). Instructions in the instruction caches may be copies of instructions in memory 504 or storage 506, and the instruction caches may speed up retrieval of those instructions by processor 502. Data in the data caches may be copies of data in memory 504 or storage 506 for instructions executing at processor 502 to operate on; the results of previous instructions executed at processor 502 for access by subsequent instructions executing at processor 502 or for writing to memory 504 or storage 506; or other suitable data. The data caches may speed up read or write operations by processor 502. The TLBs may speed up virtual-address translation for processor 502. In particular embodiments, processor 502 may include one or more internal registers for data, instructions, or addresses. This disclosure contemplates processor 502 including any suitable number of any suitable internal registers, where appropriate. Where appropriate, processor 502 may include one or more arithmetic logic units (ALUs); be a multi-core processor; or include one or more processors 502. Although this disclosure describes and illustrates a particular processor, this disclosure contemplates any suitable processor.

In particular embodiments, memory 504 includes main memory for storing instructions for processor 502 to execute or data for processor 502 to operate on. As an example and not by way of limitation, computer system 500 may load instructions from storage 506 or another source (such as, for example, another computer system 500) to memory 504. Processor 502 may then load the instructions from memory 504 to an internal register or internal cache. To execute the instructions, processor 502 may retrieve the instructions from the internal register or internal cache and decode them. During or after execution of the instructions, processor 502 may write one or more results (which may be intermediate or final results) to the internal register or internal cache. Processor 502 may then write one or more of those results to memory 504. In particular embodiments, processor 502 executes only instructions in one or more internal registers or internal caches or in memory 504 (as opposed to storage 506 or elsewhere) and operates only on data in one or more internal registers or internal caches or in memory 504 (as opposed to storage 506 or elsewhere). One or more memory buses (which may each include an address bus and a data bus) may couple processor 502 to memory 504. Bus 512 may include one or more memory buses, as described below. In particular embodiments, one or more memory management units (MMUs) reside between processor 502 and memory 504 and facilitate accesses to memory 504 requested by processor 502. In particular embodiments, memory 504 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 504 may include memory or memory units 504, where appropriate. Although this disclosure describes and illustrates particular memory, this disclosure contemplates any suitable memory.

In particular embodiments, storage 506 includes mass storage for data or instructions. As an example and not by way of limitation, storage 506 may include a hard disk drive (HDD), a floppy disk drive, flash memory, an optical disc, a magneto-optical disc, magnetic tape, or a Universal Serial Bus (USB) drive or a combination of two or more of these. Storage 506 may include removable or non-removable (or fixed) media, where appropriate. Storage 506 may be internal or external to computer system 500, where appropriate. In particular embodiments, storage 506 is non-volatile, solid-state memory. In particular embodiments, storage 506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 506 taking any suitable physical form. Storage 506 may include one or more storage control units facilitating communication between processor 502 and storage 506, where appropriate. Where appropriate, storage 506 may include one or more storages 506. Although this disclosure describes and illustrates particular storage, this disclosure contemplates any suitable storage.

In particular embodiments, I/O interface 508 includes hardware, software, or both, providing one or more interfaces for communication between computer system 500 and one or more I/O devices. Computer system 500 may include one or more of these I/O devices, where appropriate. One or more of these I/O devices may enable communication between a person and computer system 500. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 508 for them. Where appropriate, I/O interface 508 may include one or more device or software drivers enabling processor 502 to drive one or more of these I/O devices. I/O interface 508 may include one or more I/O interfaces 508, where appropriate. Although this disclosure describes and illustrates a particular I/O interface, this disclosure contemplates any suitable I/O interface.

In particular embodiments, communication interface 510 includes hardware, software, or both providing one or more interfaces for communication (such as, for example, packet-based communication) between computer system 500 and one or more other computer systems 500 or one or more networks. As an example and not by way of limitation, communication interface 510 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 510 for it. As an example and not by way of limitation, computer system 500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 500 may include any suitable communication interface 510 for any of these networks, where appropriate. Communication interface 510 may include one or more communication interfaces 510, where appropriate. Although this disclosure describes and illustrates a particular communication interface, this disclosure contemplates any suitable communication interface.

In particular embodiments, bus 512 includes hardware, software, or both coupling components of computer system 500 to each other. As an example and not by way of limitation, bus 512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 512 may include one or more buses 512, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method for creating persistent augmented scene graph information by a computing system comprising a scene graph, the method comprising:
obtaining a plurality of real-world scene graphs of a physical environment from one or more computing devices, wherein each real-world scene graph corresponds to a point of view of a computing device;
detecting a plurality of objects from the plurality of real-world scene graphs for the physical environment based on different points of view of the one or more computing devices;
determining object data comprising geometrical information, positional information, semantic information, and state information of each object within the plurality of real-world scene graphs from the different points of view;
creating composite object data of each object based on the object data, wherein the composite object data of each object is mapped to the real-world scene graph;
creating scene graph information based on the mapping of the composite object data; and
updating the scene graph information to each one or more computing devices, the scene graph information corresponds to a full view of the physical environment.

2. The method of claim 1, further comprising computing a logical relationship and a spatial relationship between each object from the different points of view.

3. The method of claim 1, wherein the scene graph information is provided to each computing device for display in a corresponding point of view.

4. The method of claim 1, further comprising:
receiving updated real-world scene graphs from the one or more computing devices; and
continuously updating the composite object data based on the received updated real-world scene graphs.

5. The method of claim 4, further comprising computing an anchor point, and an orientation point of an object based on a logical relationship and a spatial relationship between objects in each real-world scene graph.

6. The method of claim 1, further comprising determining type and characteristics of each computing device for updating the scene graph information.

7. The method of claim 6, further comprising:
modifying a particular real-world scene graph based on type and characteristics corresponding to a particular computing device using the scene graph information; and
generating a particular AR scene graph according to a point of view of the particular computing device.

8. The method of claim 1, further comprising generating audio-based output corresponding to the scene graph information according to a plurality of features of a particular computing device comprising type, characteristics, movement, position, intent of a wearer, time, and location within the physical environment.

9. A system for creating persistent augmented scene graph information, the system comprising:
one or more processors; and
one or more computer-readable non-transitory storage media in communication with the one or more processors and comprising instructions, that when executed by the one or more processors, are configured to cause the system to:
obtain a plurality of real-world scene graphs of a physical environment from one or more computing devices, wherein each real-world scene graph corresponds to a point of view of a computing device;
detect a plurality of objects from the plurality of real-world scene graphs for the physical environment based on different points of view of the one or more computing devices;
determine object data comprising geometrical information, positional information, semantic information, and state information of each object within the plurality of real-world scene graphs from different points of view;
create composite object data of each object based on the object data, wherein the composite object data of each object is mapped to the real-world scene graph;
create scene graph information based on the mapping of the composite object data; and
update the scene graph information to each one or more computing devices, the scene graph information corresponds to a full view of the physical environment.

10. The system of claim 9, wherein the instructions, when executed by the one or more processors, are further configured to cause the system to: compute a logical relationship and a spatial relationship between each object from the different points of view.

11. The system of claim 9, wherein the scene graph information is provided to each computing device for display in a corresponding point of view.

12. The system of claim 9, wherein the instructions, when executed by the one or more processors, are further configured to cause the system to:
receive updated real-world scene graphs from the one or more computing devices; and
continuously update the composite object data based on the received updated real-world scene graphs.

13. The system of claim 12, wherein the instructions, when executed by the one or more processors, are further configured to cause the system to: compute an anchor point and an orientation point of an object based on a logical relationship and a spatial relationship between objects in each real-world scene graph.

14. The system of claim 13, wherein the instructions, when executed by the one or more processors, are further configured to cause the system to: determine type and characteristics of each computing device for updating the scene graph information.

15. The system of claim 14, wherein the instructions, when executed by the one or more processors, are further configured to cause the system to:
modify a particular real-world scene graph based on type and characteristics corresponding to a particular computing device using the scene graph information; and
generate a particular AR scene graph according to a point of view of the particular computing device.

16. The system of claim 9, wherein the instructions, when executed by the one or more processors, are further configured to cause the system to: generate audio-based output corresponding to the scene graph information according to a plurality of features of a particular computing device comprising type, characteristics, movement, position, intent of a wearer, time, and location within the physical environment.

17. One or more computer-readable non-transitory storage media including instructions that, when executed by one or more processors of a computer system, are configured to cause the one or more processors to:
obtain a plurality of real-world scene graphs of a physical environment from one or more computing devices, wherein each real-world scene graph corresponds to a point of view of a computing device;
detect a plurality of objects from the plurality of real-world scene graphs for the physical environment based on different points of view of the one or more computing devices;
determine object data comprising geometrical information, positional information, semantic information, and state information of each object within the plurality of real-world scene graphs from different points of view;
create composite object data of each object based on the object data, wherein the composite object data of each object is mapped to the real-world scene graph;
create a scene graph information based on the mapping of the composite object data; and
update the scene graph information to each one or more computing devices, the scene graph information corresponds to a full view of the physical environment.

18. The media of claim 17, wherein the instructions, when executed by the one or more processors of the computer system, are further configured to:
receive updated real-world scene graphs from the one or more computing devices; and
continuously update the composite object data based on the received updated real-world scene graphs.

19. The media of claim 17, wherein the instructions, when executed by the one or more processors of the computer system, are further configured to: compute an anchor point and an orientation point of an object based on a logical relationship and a spatial relationship between objects in each real-world scene graph.

20. The media of claim 17, wherein the instructions, when executed by the one or more processors of the computer system, are further configured to:
modify a particular real-world scene graph based on type and characteristics corresponding to a particular computing device using the scene graph information; and
generate a particular AR scene graph according to a point of view of the particular computing device.
